(19) United States
(12) Patent Application Publication
(10) Pub. No.: US 2002/0092339 A1
(43) Pub. Date: Jul. 18, 2002

(54) Gas analyzing apparatus and method

(76) Inventors: Jang-Hoon Lee, Chonan-si (KR); Won-Ryul Shon, Uijungbu-si (KR); Jeong-Do Kim, Donghae-si (KR); Hyung-Gi Byun, Donghae-si (KR)

Correspondence Address: Schmeiser, Olsen & Watts LLP, 18 E. University Dr. #101, Mesa, AZ, 85201, US

(21) Appl. No.: 10/062,757

(22) Filed: Jan. 29, 2002

Related U.S. Application Data
(62) Division of application No. 09/675,022, filed on Sep. 28, 2000.

(30) Foreign Application Priority Data
May 6, 2000 (KR) 2000-24246
Apr. 4, 2000 (KR) 2000-17725
Apr. 4, 2000 (KR) 2000-17726

(51) Int. Cl. G01N 25/00

(52) U.S. Cl. 73/23.2

(57) ABSTRACT

An apparatus and a method for analyzing a gas are disclosed. The apparatus for analyzing a gas includes a filter unit for filtering impurities by gathering air, a heater for maintaining a certain temperature of a gas flown into, a dehumidifier for removing moisture contained in the gas and forming a dry gas having a certain moisture, a sensor unit having a plurality of gas sensors, moisture and temperature sensors for sensing the gathered gas having a certain set temperature and moisture, a plurality of solenoid valves for transferring the gas to the heater and dehumidifier, a display unit for displaying a result of the gas analysis, a key input unit for inputting an operation instruction and system setting value, and a control unit for transferring a data detected by the sensing unit by operating the entire system based on an operation instruction inputted into the key input unit, transferring the data detected by the sensor unit based on a connection with an external computer by on-line and analyzing the data, and controlling the entire system based on a control of the external computer for thereby easily analyzing a single gas and mixed gas using a plurality of MOS type gas sensors each having a long life time without any effect by a temperature and moisture and capable of estimating the concentration of the gas.

### BACKGROUND OF THE INVENTION

1. Field of the Invention

The present invention relates to a method and an apparatus for analyzing a gas capable of analyzing a single gas or mixed gases and estimating a gas concentration, and in particular to an apparatus for analyzing a gas which is capable of detecting a gas using a plurality of semiconductor MOS type gas sensor arrays and maintaining a constant temperature and moisture of the gas which will be measured for thereby increasing a measuring accuracy of a data when analyzing a gas and simply calibrating a data value based on the period of use.

2. Description of the Background Art

Analyzing a single gas or mixed gases accurately or estimating the concentration of a gas is required when detecting a certain gas which is harmful to the environment. In addition, it is very important to accurately analyzing a gas for a food industry, a cosmetic industry, etc. for enhancing the quality of a product by detecting the smell of a product accurately and maintaining a uniform quality of the same.

In order to analyze and measure a single gas, a gas analyzer which is capable of measuring an alcohol, methane gas, etc. using a MOS (Metal Oxide Semiconductor) type sensor is widely used in the industry. The above-described analyzer is basically directed not to analyzing a gas and measuring the concentration of the same, but to simply measuring whether the concentration of a certain gas exceeds a reference value.

A certain apparatus which is being sold in the US, Japan, Europe, etc. is used to measure a mixed gas using a sensor array instead of using one sensor or multiple sensors.

A portable analyzer among a plurality of analyzers which are currently being used for analyzing a mixed gas is convenient to use. However, it has a certain limit for calibrating an error in the temperature and moisture when analyzing a gas. Therefore, the portable analyzer is generally used for measuring a gas concentration which does not require an accurate result of the analysis. In addition, as other analyzers for analyzing a mixed gas, there are products by Osmotech PLC and AlphaMos co. The above-described products are capable of more accurately analyzing a mixed gas compared to the portable type and are expensive. The above-described products use a conducting polymer sensor array which has a short life time of a few months. In addition, the above-described products are weak against a temperature and moisture.

The currently widely used product uses a MOS type sensor. The MOS type sensor has a small variation in a resistance value based on a surrounding temperature and moisture of a work site compared to other gas sensors. However, even though the MOS type sensor has a smaller effect with respect to a surrounding environment compared to other gas sensors, the MOS type sensor receives a certain effect with respect to the temperature and moisture. The above-described problem may be a factor which prevents an accurate gas analysis and concentration measurement in a gas analyzer which adapts the MOS type gas sensor. In order to overcome the above-described problem, the analyzer must be calibrated at every certain period.

In the case that when a constant temperature and moisture is implemented with respect to the sensor, it is possible to accurately analyze a gas by changing a basic database based on a periodic calibration.

In order to implement a constant temperature and moisture for a MOS type gas sensor, in the conventional art, a cooler is used in the product, or a low temperature gas is used in a sealed space. Therefore, in this case, the size of the product is increased, and it is impossible to carry it due to a bulky size.

Therefore, in order to overcome the above-described problems, a certain gas analyzer which has a small size system for a constant temperature and moisture and is capable of easily calibrating a data based on the period of use is urgently required.

### SUMMARY OF THE INVENTION

Accordingly, it is an object of the present invention to provide an apparatus and a method for analyzing a gas capable of easily analyzing a single gas and mixed gas using a plurality of MOS type gas sensors each having a long life time without any effect by a temperature and moisture and capable of estimating the concentration of the gas.

It is another object of the present invention to provide an apparatus for analyzing a gas capable of increasing an analyzing accuracy of a gas concentration and having an easily exchangeable filter by providing a heater and dehumidifier for a constant temperature and moisture.

It is another object of the present invention to provide an apparatus for analyzing a gas capable of preventing a drift phenomenon due to a variation in a resistance of a sensor based on the period of use.

It is another object of the present invention to provide a method for analyzing a gas capable of implementing an easier data transmission and a result analysis using an external computer connection through a communication network.

In the present invention, it is possible to estimate the concentration by classifying a VOC(Volatile Chemical Compound) gas which is an environmental restriction gas. In the present invention, the VOC gas capable of being classified and estimated for its concentration includes a group comprising methanol, ethanol, propanol, hexane, cyclohexane, heptane, acetic ether, benzene, toluene, ethylbenzene, xylene, p-xylene, carbon tetrachloride, chloroform, ethylene, trichloroethylene, tetrachloroethylene, acetaldehyde and acetylene. The above-described compounds are not limited thereto. More gas classifications and analysis may be implemented by increasing the number of the sensors of the sensor array unit (28) of the gas analyzer and analyzing the gases.

In the present invention, it is possible to detect and analyze the smell of a product in a high molecular industry such as good, cosmetic, drink, perfume, rubber and plastic using the gas analyzer according to the present invention and controlling the processes for obtaining an enhanced quality.

In order to achieve the above objects, there is provided a gas analyzer (1) which includes a filter unit (12) for filtering impurities by gathering air, a heater (22) for maintaining a certain temperature of a gas flown into, a dehumidifier (24) for removing moisture contained in the gas and forming a dry gas having a certain moisture, a sensor unit (28) having a plurality of gas sensors, moisture and temperature sensors for sensing the gathered gas having a certain set temperature and moisture, a plurality of solenoid valves (16, 18, 20, 32) for transferring the gas to the heater and dehumidifier, a display unit (42) for displaying a result of the gas analysis, a key input unit (44) for inputting an operation instruction and system setting value, and a control unit (36) for transferring a data detected by the sensing unit by operating the entire system based on an operation instruction inputted into the key input unit, transferring the data detected by the sensor unit based on a connection with an external computer (40) by on-line and analyzing the data, and controlling the entire system based on a control of the external computer.

In addition, there is provided a gas analyzing method according to the present invention which includes (a) a zero gas generation mode for generating a zero gas for identically determining the reference of all analysis object gas, gathering air and feeding back the same, detecting the same using a sensor unit, and analyzing and forming the thusly obtained value into a database, (b) an inlet and feed-back mode of an analysis object gas for maintaining a constant temperature and moisture by introducing and feeding back the analysis object gas and maintaining a constant temperature and moisture, detecting the same using the sensor unit and analyzing the same and storing the thusly obtained into the database, and (c) a classification mode for computing a difference between the data of the zero gas measured by the sensor unit and the data in the stable state of the analysis object gas and classifying the classification mode.

The gas analyzer according to the present invention may be used for classifying a harmful gas(in particular, VOC gas) and estimating the concentration of the gas. In this case, the (c) classification mode includes a concentration estimation mode capable of learning the reference data which is a previously measured accurate data using the artificial neural network for thereby estimating the concentration of the analysis object concentration having a corrected error.

The gas analyzing method according to the present invention may be used for clustering(PCA, non-linear mapping) the smell of a sample such as food, drink, medicine, rubber, plastic, etc. and classifying the gas the kind of the gas. In this case, the classification mode includes an analysis mode capable of analyzing the kind of the analysis object gas using a linear projection method and a non-linear mapping method or a method combined with the above-described two methods(hereinafter, called as an analysis process).

The gas analyzer according to the present invention has a constant temperature and moisture characteristic so that it is possible to correct the error of the sensor based on a periodic correction of the data. In addition, the constriction of the system for analyzing and estimating a single gas and a mixed gas is minimized, and a portable system may be implemented. In addition, since it is possible to monitor a harmful environment in real time, the gas analyzer according to the present invention may be user for a work site where requires a gas analysis. It is possible to analyze the data transmission measured based on a connection with an external computer using a communication network and to remotely control the schedule.

In addition, the data analyzing method according to the present invention has a data pattern of a non-linear component of a gas and smell by converting a multi-dimension to a low dimension pattern using a non-linear mapping method and a linear projection method, so that it is possible to significantly decrease the conversion error which occurs due to a signal distortion and during a conversion from a multi-dimension pattern to a low dimension pattern. In addition, an error is minimized for changing a gas and smell data pattern to a low dimension, so that a distribution of a data pattern is implemented, and a rotation phenomenon of an axis does not occur, and an accuracy for analyzing and clustering is enhanced.

### BRIEF DESCRIPTION OF THE DRAWINGS

The present invention will become better understood with reference to the accompanying drawings which are given only by way of illustration and thus are not limitative of the present invention, wherein;

FIG. 1 is a view illustrating a gas analyzer according to the present invention;

FIG. 2 is a view illustrating a filter unit used in a gas analyzer according to the present invention;

FIG. 3 is a view illustrating a dehumidifier user in a gas analyzer according to the present invention;

FIG. 4A is a view illustrating a sensor unit used in a gas analyzer according to the present invention;

FIG. 4B is a view illustrating a front portion of a sensor unit used in a gas analyzer and an engaged state of the same according to the present invention;

FIG. 5 is a view illustrating a structure(LMBP method) of a artificial neural network according to the present invention;

FIG. 6 is a view illustrating a classification and a concentration estimation value based on an actually measured data according to the present invention;

FIG. 7 is a flow chart of a measurement data classification method of a gas and smell sensing system implemented by a linear projection method and non-linear mapping method used when analyzing a data measured by a gas analyzer according to the present invention;

FIG. 8A is a view of a result of a measurement data classification obtained by a linear projection method according to the present invention;

FIG. 8B is a view of a result of a measurement data classification obtained by a non-linear projection method according to the present invention;

FIG. 8C is a view of another result of a measurement data classification obtained by a non-linear projection method according to the present invention; and

FIG. 8D is a view of a result of a classification regarding a gas and smell measured using both a linear projection method and a non-linear projection method according to the present invention.

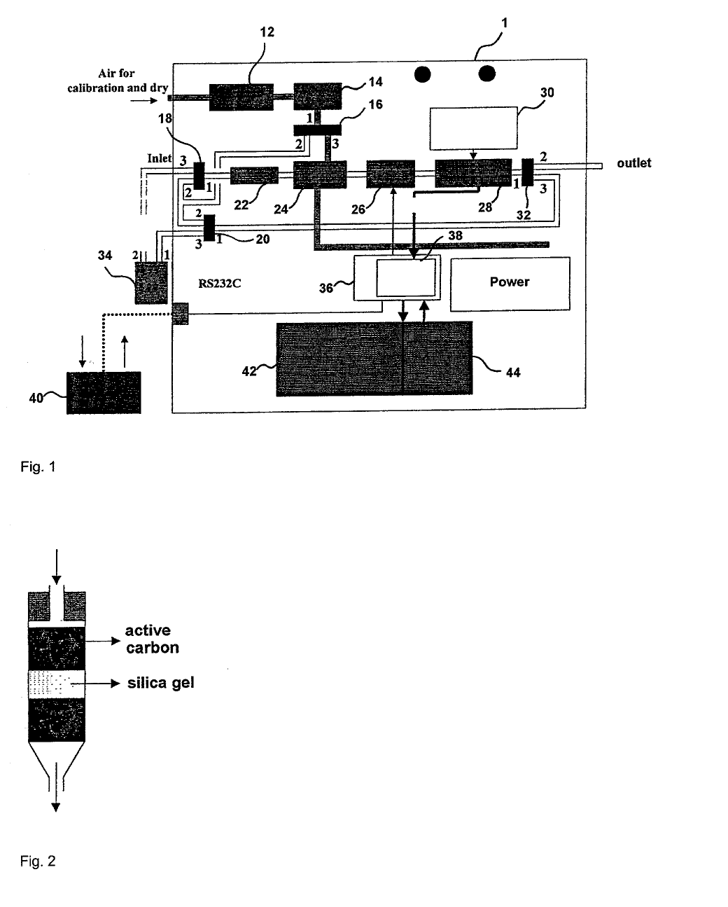

### DETAILED DESCRIPTION OF THE PREFERRED EMBODIMENTS

Measurement Process

A first embodiment of the present invention is directed to a measurement process capable of classifying a harmful gas(in particular, a VOC gas) and includes a zero gas generation mode (1), an analysis object gas inlet and feed-back mode (2), and an analysis object gas classification mode (3). The first embodiment of the present invention will be explained with reference to the accompanying drawings.

Zero Gas Generation Mode

First, this mode is directed to identically determining all gas references. The zero gas represents air having a pure state which does not contain gas and moisture and is obtained using a filter (12) of FIG. 2. The filter (12) is formed of an silica gel and a active carbon such as carbon which have a good absorption characteristic. The portion of silica gel may be substituted with another absorption agent based on the kind of gas which will be eliminated. When the above-described gas is obtained using the filter (12), pumps 1(14) and 2(26) operate, and a solenoid valve is closed based on the following sequences for thereby guiding the flow of the gas. Here, when one side of the value is opened, the other side of the same is closed.

The numbers 1 and 2 of the solenoid 1 (16) are opened.

The numbers 1 and 2 of the solenoid 2 (18) are opened.

The numbers 1 and 2 of the solenoid 3 (20) are opened.

The numbers 1 and 2 of the solenoid 4 (32) are opened. After about 3 seconds, the numbers 1 and 3 are opened. The zero gas is flown into the sensor unit and becomes a reference gas of the sensor data of a sensor array unit (28).

Inlet and Feed-Back Mode of Gas

In the case that a harmful gas(in particular, a VOC gas) is classified, and the concentration of the same is estimated according to the present invention, when a gas which will be measured is flown into the entrance, the pump 1 (14) does not operate, and the pump 2 (26) operates. The solenoid value is opened based on the following sequences.

The numbers 1 and 3 of the solenoid 1 are opened.

The numbers 2 and 3 of the solenoid 2 are opened.

The numbers 3 and 1 of the solenoid 3 are opened.

The numbers 4 and 1 of the solenoid 4 are opened. After about 2˜3 seconds, The numbers 3 and 1 of the solenoid value are closed.

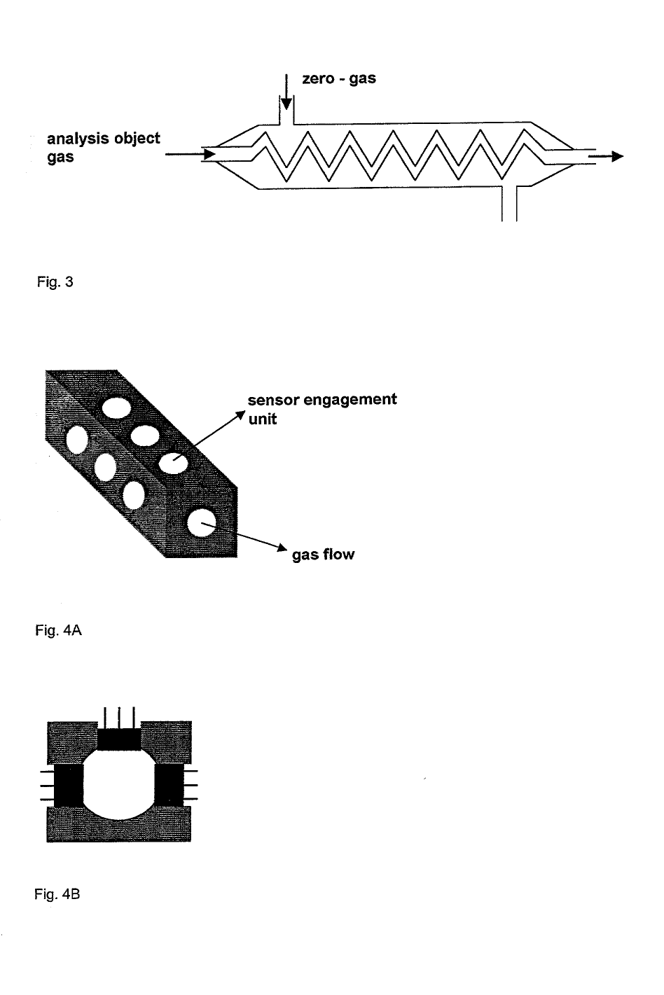

When the numbers 1 and 3 of the solenoid value are opened, an analysis object gas is flown into the dehumidifier (24) through a heater (22) installed around a copper pipe. The numbers 1 and 3 of the solenoid valve 1 (16) are opened, and the zero gas which has a certain temperature lower than an analysis object gas is flown into the pipe of the dehumidifier (24) as shown in FIG. 3 and is flown to the outside of the measuring unit.

The moisture is removed from the analysis object gas which has a warm temperature by a cold zero gas, and the analysis object gas is flown into the sensor array. The sensor array unit (28) which is formed of another kind of sensor is capable of a data measured by the sensor driving unit and AD converter to a microprocessor.

The numbers 1 and 2 of the solenoid valve 2 (18) are opened after a certain time and are disconnected with an external gas, and the gas passed through the sensor array unit (28) is fed back based on the opening of the numbers 1 and 3 of the solenoid valve 4 (32) and circulate therein for a certain time(preferably, about more than 30 seconds) and has a certain temperature and moisture based on the heater (22) and the sensor heater of the sensor array unit (28) for thereby compensating the characteristic of the sensor which has a certain displacement based on the temperature and moisture. At this time, the flow rate in the pump 2 (26) is preferably maintained at below about 400 ml.

The sensor data of the sensor array unit (28) becomes a stable state after a certain circulation. Therefore, there is not any change. In the normal state, a difference between the data of each sensor and the data in the zero gas state of each sensor is used for classifying the gas and estimating the concentration of the same.

At this time, the sensor array unit (28) is formed of teflon which is thermally stable in a square rod shape. The shape of the sensor array unit is not limited thereto. Namely, the shape of the same may be circular, triangle, pentagonal. The inner hole through which the gas flows may be circular. The shape of the same may be changed. Gas sensors, temperature sensor, moisture sensor, etc. may be engaged to the sensor array unit.

Analysis Object Gas Classification and Concentration Estimation Mode

The next step is the classification and concentration estimation mode. In this mode, a difference between the data of the analysis object gas which is measured in the stable state and the sensor data in the zero gas state is computed, and the analysis and classification are implemented using the computed difference.

In the case that the mixed gas such as VOC gas is analyzed, since the measurement of the concentration is important, the LM-BP method is used as an analyzing algorism. For example, in the case of the gas mixed with benzen, toluen, trichloroethylen, in order to measure the above-described mixed gas, a sample gas is learned for a formation of the database. At this time, the learning operation is performed based on the state that the number of neurons of an output layer is 4(three is for class of each gas, and one is for a concentration data output).

The classification and concentration estimation algorithm and the database formation method will be explained.

When a certain gas is measured using a reference data which is a previously measured data, in order to classify the kind of the material and estimate the concentration, the reference data is learned and is inserted into the database. The reference data uses three ppm levels per each gas for the description. The reference data must have three densities per each gas. Preferably, more densities may be used.

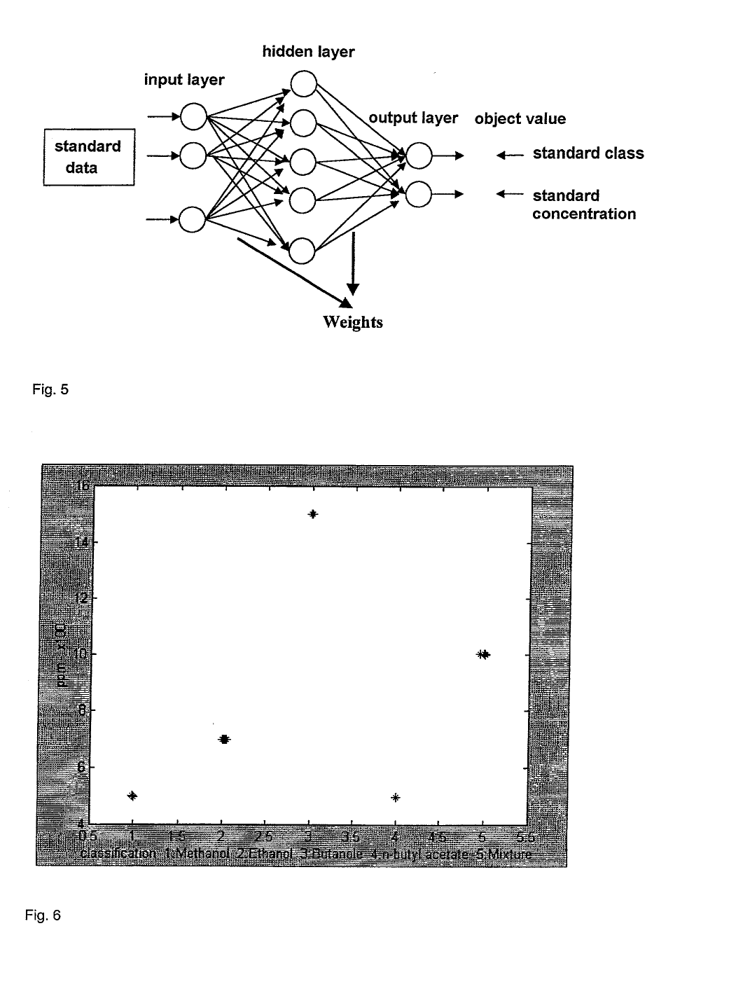

For the learning method for the classification and concentration estimation, a LM-BP(Levenberg-Marquardt BackPropagation) method is used. FIG. 5 illustrates the structure of a known multi-layer perception used in the LM-BP. Assuming a connection between layers as a weight as shown in FIG. 5, the weight is learned to have a proper value based on the repeating learning operation. The number of the repetitions may be determined until a SSE(Square Sum Error) between the output of the output layer and the destination value converges to a determined error range. In the LM-BP neural network according to the present invention, two neuros in output layers are used, and the neuron 1 of the output layer represents a class which is classified, and the neuron 2 represents the concentration value.

The learning algorithm of the LM-BP may be expressed as follows.

[Equation 1]

Δ=(H+λI)⁻¹g

W=W+Δ

where W represents the weight matrix of the entire neural network, H represents the Hessian matrix, I represents the identity matrix, and g represents the Gradient matrix.

Here, the learned weight is stored into the database formed in the EEPROM and the PC software and is used for an actual measurement and analysis.

In an actual measurement, when the gathered gas is flown into the sensor unit, the data is obtained. An over response value is subtracted from the above-described data for thereby obtaining a certain value. This value is used for the analysis. At this time, the weight value stored in the database is obtained for thereby outputting a classification value and concentration value based on an entire direction computation of the BP neural network.

Since the neuron circuit network has a generalization characteristic, even when the data of the non-learned concentration is inputted, a desired concentration and class are outputted based on the adaptation.

FIG. 6 is a view illustrating a result obtained by actually estimating an actual data using the weight with respect to five learned weights. As shown therein, a gas corresponding to an ethanol 750 ppm and a gas of buthanol 1500 ppm are injected for thereby estimating the classification value and concentration. As a result, a good value without any error is obtained.

FIG. 6 illustrates four gases and one mixed gas. In the system according to the present invention, almost VOC gases are capable of classifying and estimating the concentration. If 12 sensors are formed in the array, about 10 VOC gases are classified, and the densities of the same are estimated for thereby enhancing the accuracy.

A re-calibration operation is performed as follows for minimizing the error based on the Drift phenomenon.

In the gas sensor, a drift phenomenon occurs based on the elapse of time. Therefore, an error may be increased when the data stored in the database in the past is used for estimating a proper value in the present time. Namely, as shown in FIG. 6, the ethanol of the number 2 class is accurately estimated. In this case, there may be a difficulty for determining the class due to the error. In addition, an error may be increased in the estimation value with respect to the concentration. Therefore, in the re-calibration operation, the data previously used for obtaining the weight and a new data may be learned together for thereby obtaining a new weight and forming a database and may be used for a classification and concentration estimation.

Analysis Process

The second embodiment of the present invention is directed to an analysis process capable of clustering a smell of a sample such as drink, medicine, rubber, plastic, etc. The analysis process according to the second embodiment of the present invention includes a zero gas generation mode(1), a gas inlet and feed-back mode(2), and a classification and concentration estimation mode(3) similarly to the first embodiment of the present invention. The second embodiment of the present invention may be explained as follows.

Zero Gas Generation Mode

The second embodiment of the present invention needs to cluster a smell of a sample such as food, drink, medicine, rubber, plastic, etc.(PCA, non-linear mapping) and analyze the kind of the same. The operation of the pump is the same as the first embodiment of the present invention. In addition, the second embodiment of the present invention is the same as the first embodiment of the present invention except for that the numbers 1 and 3 of the solenoid valve 3 (20) are opened. In this case, the numbers 1 and 2 of the solenoid valve 3 (20) are closed all the time, and the inlet 3 of the solenoid valve 2 (18) is connected with the number 2 of the sample bottle (34). A sample which will be analyzed is inserted into the sample bottle (34). The analysis object gas circulates in the entire loop and has a certain temperature and moisture. The sensor use measures the data. When the circulation is maintained for a certain time, a stable state is obtained, and then the data is measured. The construction of the sensor unit and the inlet of the analysis object gas and the feed-back mode are the same as the first embodiment of the present invention except for the above-described different construction and operation.

Analysis Object Gas Classification and Analysis Mode

In the mixed gas, the measurement of the concentration is not needed. There are only an analysis method for classifying the smell and an analysis gas analyzing method which needs a concentration measurement. The smell which occurs in the industry such as food, drink, medicine, rubber, plastic, etc. is formed of a mixed gas, not a single gas. In the above-described gas, the measurement of the concentration is not needed.

In this mode, a difference between the data measured in the stable state and the sensor data in the zero gas state is computed, and the classification and analysis are performed using the computed difference. The analysis algorithm which is used in the above-described process is a linear projection method (preferably, PCA(Principle Component Analysis)) method, a non-linear projection method, and a combined method of the same.

The gas and smell measured and detected by the gas and smell measurement system which uses a plurality of gas and smell measurement sensors in one array system are displayed in different patterns of the multi-dimensional system. It is very difficult to analyze and classify the gas and smell based on the multi-dimensional patterns.

As a method for forming a multi-dimensional pattern to a low dimensional pattern, there is a linear projection or a non-linear mapping method. In the linear projection method, all information of the multi-dimensional patterns are not included in a low dimensional pattern, a signal distortion may occur, and the data pattern measured by the gas and smell measurement system which includes a lot of non-linear pattern components has many errors in the low-dimensional linear projection method.

The non-linear mapping method does not has a large projection error differently from the linear-projection method, but has a rotation phenomenon of the data mapped to a low dimension based on a database input sequence of the measured multi-dimensional gas and smell patterns.

In the present invention, a method combined with a linear projection method and a non-linear mapping method is disclosed except for the above-described linear projection method and non-linear projection method. The above-described combined method overcomes the problems encountered in the conventional art which has a problem for converting the high dimensional pattern to a low dimension pattern based on the gas and smell measurement system. In the present invention, a method capable of classifying the measured gas and smell using a visual ability of human without a specific technique is disclosed.

Generally, the gas and smell measured by the gas and smell measurement system adapts the non-linear mapping method for decreasing a signal distortion and a conversion error between the high dimension pattern and the converted low dimension pattern based on the non-linear component as follows.

$$E = \frac{1}{{Q}_{i < j} [ {d}_{ij}^{*} ]} {{Q}_{i < j}}^{N} \frac{{[ {d}_{ij}^{*} - {d}_{ij} ]}^{2}}{{d}_{ij}^{*}}$$

where dᵢⱼ represents a distance between the multi-dimensional pattern i and the multi-dimensional pattern j, d*ᵢⱼ represents a distance between the low dimensional(2 or 3 dimension) patterns i and j, and L represents the number of the entire measured patterns.

In the Equation 1, d*ᵢⱼ which minimizes the value E is obtained based on the Gradient method, and the gas and smell data which are visually measured are analyzed by computing each low dimension pattern and displaying the same based on the 2 or 3 dimension. However, The patterns i and j which are initialized for obtaining d*ᵢⱼ are formed by the random values. Different results are obtained based on the condition of the initial random values, and different results are obtained based on the input sequence of the measured multi-dimensional patterns. As a result, the non-linear mapping method obtains a result that the low dimension patterns rotate about the axis whenever the routine is performed. The above-described mapping result may cause a certain difficulty in order for an observer to analyze and judge. In order to prevent the above-described rotation of the axis, the principle component analysis(PCA) which is the linear projection method is adapted for thereby initializing d*ᵢⱼ. In the PCA method for initializing d*ᵢⱼ, an inherent value and inherent vector are sequentially arranged by the order of the sizes using Jacobian method, and the following low dimension pattern may be obtained based on the linear method using an inherent vector based on the largest inherent value and an inherent vector based on the second largest value in the case of the two dimension.

where i represents the high dimension(L-dimension) which is actually measured, and I represents the number of patterns, and K represents the converted low dimension(k=2 or 3).

d*ᵢⱼ is initialized using the above-described method and is used as an initialization value of the patterns for a non-linear mapping for thereby analyzing the distribution of the low dimension patterns even when the input sequences of the multi-dimensional measurement patterns are changed. The above-described analysis method is capable of visually analyzing an actual measurement value of the gas and smell measurement system and is well adapted to the system.

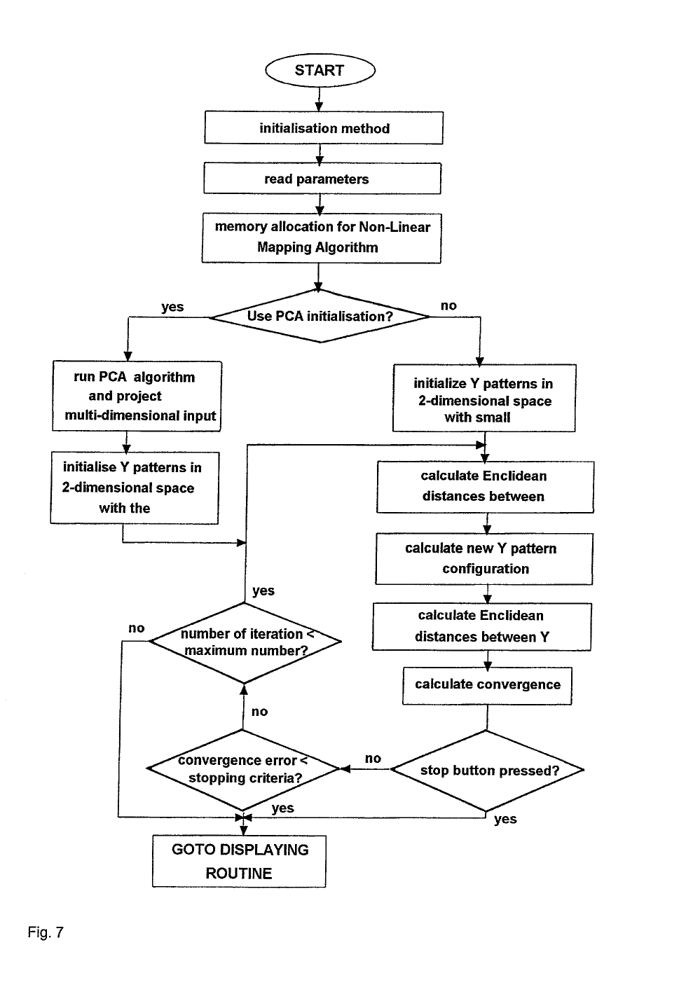

FIG. 7 is a flow chart of a measurement data classification method of a gas and smell measurement system implemented by a linear projection method and a non-linear mapping method according to the present invention.

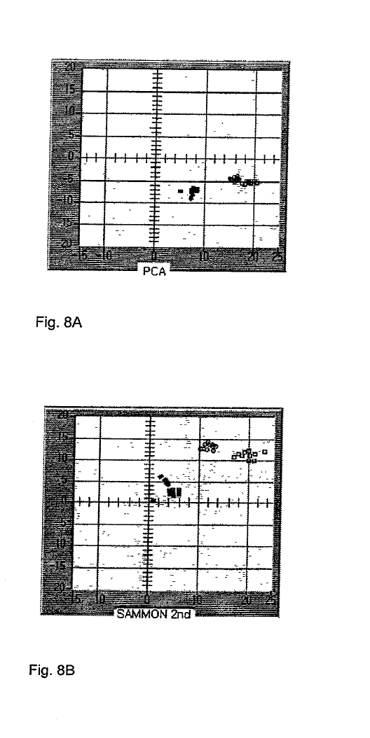

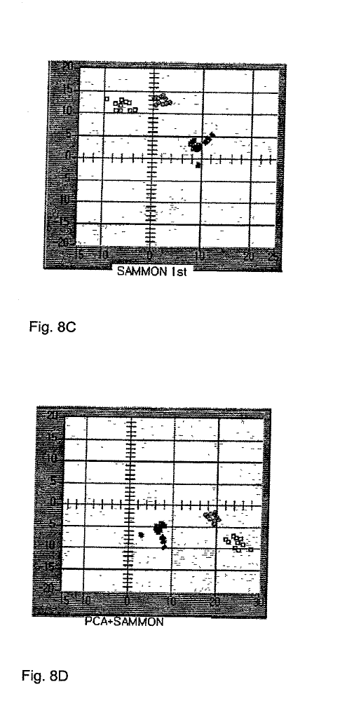

FIG. 8A is a view illustrates a result of a classification which is implemented by the linear projection method. As shown therein, a good classification is not obtained due to the distortion of the data. FIGS. 8B and 8C illustrate better classifications obtained by the non-linear projection method compared to the linear projection method. In this case, different initialization conditions are provided, an axis rotation phenomenon of the data occurs due to the initial condition. FIG. 8D illustrates a result of the classification with respect to the gas and smell measured using a combination of the linear projection method and the non-linear mapping method. As shown therein, there are good classification result without the rotation of the axis.

As the present invention may be embodied in several forms without departing from the spirit or essential characteristics thereof, it should also be understood that the above-described embodiments are not limited by any of the details of the foregoing description, unless otherwise specified, but rather should be construed broadly within its spirit and scope as defined in the appended claims, and therefore all changes and modifications that fall within the meets and bounds of the claims, or equivalences of such meets and bounds are therefore intended to be embraced by the appended claims.

What is claimed is:

1. In a gas analyzer capable of analyzing a single or mixed gas using a MOS type gas sensor, an improved gas analyzer, comprising:
a filter unit for filtering impurities by gathering air;
a heater for maintaining a certain temperature of a gas flown into;
a dehumidifier for removing moisture contained in the gas and forming a dry gas having a certain moisture;
a sensor unit having a plurality of gas sensors, moisture and temperature sensors for sensing the gathered gas having a certain set temperature and moisture;
a plurality of solenoid valves for transferring the gas to the heater and dehumidifier;
a display unit for displaying a result of the gas analysis;
a key input unit for inputting an operation instruction and system setting value; and
a control unit for transferring a data detected by the sensing unit by operating the entire system based on an operation instruction inputted into the key input unit, transferring the data detected by the sensor unit based on a connection with an external computer by on-line and analyzing the data, and controlling the entire system based on a control of the external computer.

2. A gas analyzer of claim 1, further comprising pumps for controlling the flow of the gas and air.

3. A gas analyzer of claim 1, where in said dehumidifier removes the moisture from the gas by making air having lower temperature lower than the gas flow into the pipe of the dehumidifier.

4. A gas analyzer of claim 1, wherein said filter unit is formed of an absorption material layer between active carbons.

5. A gas analyzer of claim 2, wherein said absorption material is made of alumina gel.

6. A gas analyzer of claim 2, wherein said VOC gas analyzed by the gas analyzer is selected from the group comprising methanol, ethanol, ethanol, propanol, hexane, cyclohexane, heptane, acetic ether, benzene, toluene, ethylbenzene, xylene, p-xylene, carbon tetrachloride, chloroform, ethylene, trichloroethylene, tetrachloroethylene, acetaldehyde and acetylene.

7. A gas analyzer of claim 1, wherein when the temperature of the measurement gas is lower than a set temperature, the heater is operated, and a constant temperature and constant moisture characteristic are obtained by operating a dehumidifier for properly maintaining the moisture of the measurement gas.

8. A gas analyzer of claim 1, wherein said sensor unit is formed of a teflon.

9. In a gas analyzing method for classifying and analyzing a gas and mixed gas and estimating a concentration of the same, an improved gas analyzing method, comprising:
(a) a zero gas generation mode for generating a zero gas for identically determining the reference of all analysis object gas, gathering air and feeding back the same, detecting the same using a sensor unit, and analyzing and forming the thusly obtained value into a database;
(b) an inlet and feed-back mode of an analysis object gas for maintaining a constant temperature and moisture by introducing and feeding back the analysis object gas and maintaining a constant temperature and moisture, detecting the same using the sensor unit and analyzing the same and storing the thusly obtained into the database; and
(c) a classification mode for computing a difference between the data of the zero gas measured by the sensor unit and the data in the stable state of the analysis object gas and classifying the classification mode.

10. The method of claim 9, wherein said classification mode (c) includes a concentration estimation mode for learning a reference data which is a previously measured accurate data based on an artificial neural network and estimating the concentration of an analysis object gas having a corrected error.

11. The method of claim 9, wherein said classification mode (c) includes an analysis mode capable of analyzing the kind of an analysis object gas using a linear projection method, a non-linear mapping method or a combined method of the linear projection method and the non-linear mapping method.

12. The method of claim 9, wherein in said analysis object gas inlet and feed-back mode, when the analysis gas circulates around a heater, dehumidifier and sensor array unit for a certain number and becomes a stable state, the above-described state is detected and is analyzed, and the thusly analyzed value is stored into a database.

13. The method of claim 10, wherein an algorithm used when measuring the concentration of the gas measured in the classification mode is a LM-BP (Levenberg-Marquardt Back-Propagation) method among the artificial neural network methods.

14. The method of claim 11, wherein in the classification mode, the algorithm used for analyzing the kind of the gas measured is directed to a linear projection method, a non-linear projection method or a combined method of the linear projection method and the non-linear projection method.

15. The method for claim 14, wherein said linear projection method is a PCA(Principle Component Analysis).
